(19) United States
(12) Patent Application Publication
(10) Pub. No.: US 2025/0124742 A1
(43) Pub. Date: Apr. 17, 2025

(54) MIXED REALITY DEVICE, PROCESSING METHOD, PROCESSING DEVICE AND STORAGE MEDIUM

(71) Applicant: KABUSHIKI KAISHA TOSHIBA, Tokyo (JP)

(72) Inventors: Hiroaki NAKAMURA, Kawasaki Kanagawa (JP); Takanori Yoshii, Kawasaki Kanagawa (JP); Yoshiyuki HIRAHARA, Mishima Shizuoka (JP); Kyotaro HAYASHI, Yokohama Kanagawa (JP); Takehiro KATO, Yokohama Kanagawa (JP); Yasuo NAMIOKA, Nerima Tokyo (JP)

(21) Appl. No.: 18/910,629

(22) Filed: Oct. 9, 2024

(30) Foreign Application Priority Data
Oct. 11, 2023 (JP) 2023-176069

(51) Int. Cl. G06V 40/20; G06T 7/73; G06T 19/00; G06V 10/75; G06V 20/50

(52) U.S. Cl. CPC G06V 40/28; G06T 7/73; G06T 19/006; G06V 10/751; G06V 20/50; G06T 2207/30196; G06T 2207/30204

(57) ABSTRACT

According to one embodiment, a mixed reality device includes an imaging part and a processing part. The imaging part is configured to acquire an image. The processing part is configured to recognize, from the image, a hand of a worker performing a fastening task. The processing part is further configured to determine whether the fastening task is appropriate based on a first distance between a first position corresponding to a fastening location of a screw and a second position of the hand holding a first tool.

### CROSS-REFERENCE TO RELATED APPLICATIONS

This application is based upon and claims the benefit of priority from Japanese Patent Application No. 2023-176069, filed on Oct. 11, 2023; the entire contents of which are incorporated herein by reference.

### FIELD

Embodiments of the present invention generally relate to a mixed reality device, a processing method, a processing device, and a storage medium

### BACKGROUND

In the tasks of manufacturing an article, a mixed reality device may be used. There is a need for technology that can suppress inappropriate task from being performed during fastening tasks using mixed reality devices.

### BRIEF DESCRIPTION OF THE DRAWINGS

FIG. 1 is a schematic diagram illustrating a configuration of a processing system according to a first embodiment;

FIG. 2 is a schematic view illustrating a mixed reality device according to an embodiment;

FIG. 3 is a schematic view illustrating an article to be worked;

FIG. 4 is a schematic view for explaining the first embodiment of the present invention;

FIGS. 5A and 5B are schematic views for explaining the first embodiment of the present invention;

FIGS. 6A and 6B are schematic views for explaining the first embodiment of the present invention;

FIGS. 7A and 7B are schematic views for explaining the first embodiment of the present invention;

FIGS. 8A and 8B are schematic views for explaining the first embodiment of the present invention;

FIG. 9 is a flowchart illustrating a processing method according to the first embodiment;

FIGS. 10A and 10B are schematic views for explaining a second embodiment of the present invention;

FIGS. 11A and 11B are schematic views illustrating output examples in the second embodiment of the present invention;

FIG. 12 is a flowchart illustrating an example of a processing method according to the second embodiment;

FIG. 13 is a flowchart illustrating a processing method according to a first modification of the second embodiment;

FIG. 14 is a schematic view for explaining a second modification of the second embodiment;

FIG. 15 is a flowchart illustrating a processing method according to the second modification of the second embodiment;

FIG. 16 is a schematic view for explaining a third embodiment of the present invention;

FIG. 17 is a schematic view for explaining the third embodiment of the present invention;

FIG. 18 is a flowchart illustrating a processing method according to the third embodiment;

FIG. 19 is a flowchart illustrating an outline of data processing in the processing method according to the embodiment; and

FIG. 20 is a schematic diagram illustrating a hardware configuration.

### DETAILED DESCRIPTION

According to one embodiment, a mixed reality device includes an imaging part and a processing part. The imaging part is configured to acquire an image. The processing part is configured to recognize, from the image, a hand of a worker performing a fastening task. The processing part is further configured to determine whether the fastening task is appropriate based on a first distance between a first position corresponding to a fastening location of a screw and a second position of the hand holding a first tool.

Embodiments of the invention will now be described with reference to the drawings.

The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

In the drawings and the specification of the application, components similar to those described thereinabove are marked with like reference numerals, and a detailed description is omitted as appropriate.

### First Embodiment

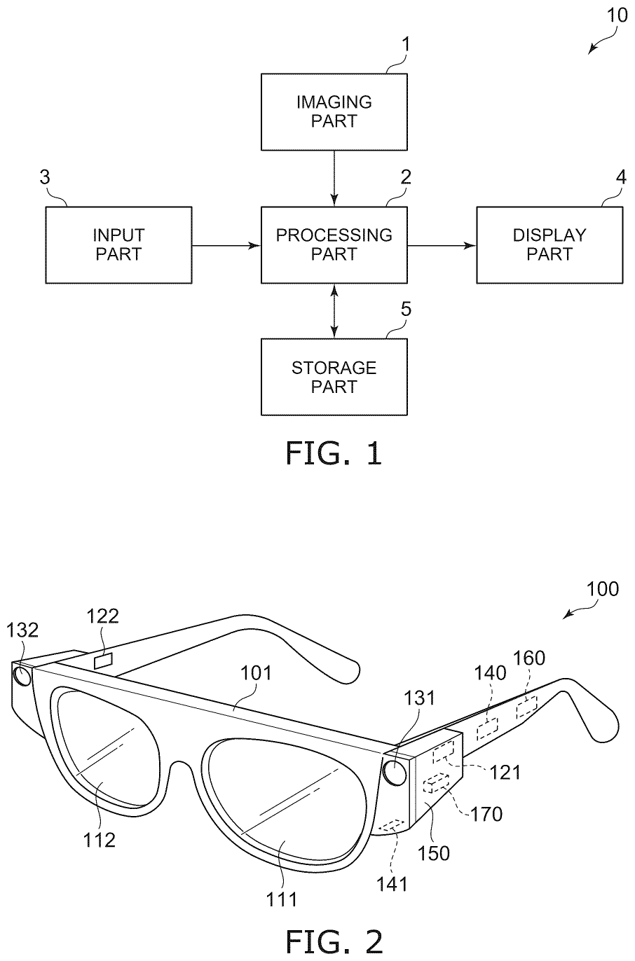

FIG. 1 is a schematic view illustrating a configuration of a processing system according to a first embodiment.

The first embodiment of the present invention is applicable to task using a tool. As shown in FIG. 1, the processing system 10 includes an imaging part 1, a processing part 2, an input part 3, a display part 4, and a storage part 5.

The imaging part 1 images the appearance of the task. Specifically, in the task, a fastener such as a screw is tightened to the article using a tool. An article is a part for manufacturing a product, a unit, or a semi-finished product. Tools may be a wrench, a screwdrivers, or etc.

When assembling an article, the worker holds the tool in the hand and tightens the screws. The imaging part 1 images the left or right hand of the worker holding the tool. For example, the imaging part 1 includes a camera that acquires an RGB image and a depth image.

The processing part 2 receives a continuous image (movie) imaged by the imaging part 1. The processing part 2 recognizes the left hand or right hand in the image. Hand tracking is used for recognition of the left or right hand. Hereinafter, when there is no particular distinction between the left hand and the right hand, at least one of the left hand and the right hand is simply referred to as “the hand”.

The processing part 2 accepts the designation of the fastening location of a screw through the movie. As a specific example, the fastening location is indicated by a hand gesture using the worker's hand (eg, finger). When the worker points to the fastening location, the processing part 2 recognizes the movement of the hand and recognizes the first position of the tip of the finger. The processing part 2 accepts the first position as the fastening location of a screw and measures the first position.

The processing part 2 further recognizes the second position of the hand holding the tool (first tool) and measures the second position. For example, the hand holding the tool or the handedness of the worker is registered in advance. The processing part 2 recognizes the registered hand and measures the position as the second position. More specifically, the hand includes multiple joints, such as DIP joints, PIP joints, MP joints, CM joints, etc. The position of any of these joints is used as the position of the hand. The position of the center of gravity of the multiple joints may be used as the position of the hand. Alternatively, the overall center position of the hand may be used as the position of the hand.

The first position and the second position each are represented by coordinates in a predetermined three-dimensional coordinate system. The order of measurement of the first and second positions is arbitrary. The first position may be measured after the second position, or the second position may be measured after the first position.

The processing part 2 calculates the first distance between the first position and the second position. The first distance when the screw is tightened corresponds to the length of the tool used to tighten the screw. The processing part 2 determines whether the fastening task being performed is appropriate based on the first distance.

The input part 3 is used by the worker to input information to the processing part 2. The input part 3 includes a microphone. The worker can input information to the processing part 2 by uttering to the input part 3. For example, at a timing when the first position is measured by the processing part 2, at a timing when the second position is measured by the processing part 2, or etc., the voice corresponding to a voice command is input to the input part 3. In addition to the input part 3, the worker can input information to the processing part 2 by hand gesture or the like.

The display part 4 displays information to the worker. For example, the display part 4 displays the left hand and right hand recognized by the processing part 2, a virtual object indicating the first position, a virtual object indicating the second position, etc. If it is determined that the fastening task is not appropriate by the processing part 2, information indicating that the fastening task is not appropriate may be displayed on the display part 4.

The storage part 5 stores data necessary for the processing part 2, data obtained by the processing part 2, etc. For example, data of the tool used in the task is registered in the storage part 5. The registered data includes information necessary to specify the length of the tool, such as the model of the tool. The length of the tool may be registered. The processing part 2 determines whether the fastening task is appropriate by comparing the length of the tool obtained from the data of the storage part 5 with the first distance.

FIG. 2 is a schematic view illustrating a mixed reality device according to the embodiment.

The processing system 1 shown in FIG. 1 is realized, for example, as a mixed reality (MR) device. The MR device 100 shown in FIG. 2 includes a frame 101, a lens 111, a lens 112, a projection device 121, a projection device 122, an image camera 131, a depth camera 132, a sensor 140, a microphone 141, a processing device 150, a battery 160, and a storage device 170.

The image camera 131 and the depth camera 132 are examples of the imaging part 1. The processing device 150 is an example of the processing part 2. The microphone 141 is an example of the input part 3. The projection device 121 and the projection device 122 are examples of the display part 4. The storage device 170 is an example of the storage part 5.

In the illustrated example, the MR device 100 is a binocular-type head-mounted display. Two lenses 111 and 112 are embedded in the frame 101. The projection devices 121 and 122 project information onto lenses 111 and 112, respectively.

The projection device 121 and the projection device 122 display the recognition result of the worker's body, a virtual object indicating the first position, a virtual object indicating the second position, etc. on the lens 111 and the lens 112. Only one of the projection device 121 and the projection device 122 may be provided, and information may be displayed on only one of the lens 111 and the lens 112.

The lens 111 and the lens 112 are transparent. The worker can see the real-space environment through the lens 111 and the lens 112. The worker can also see the information projected onto the lens 111 and the lens 112 by the projection device 121 and the projection device 122. The projections by the projection device 121 and the projection device 122 display information overlaid on the real space.

The image camera 131 detects visible light and acquires a two-dimensional image. The depth camera 132 emits infrared light and acquires a depth image based on the reflected infrared light. The sensor 140 is a 6-axis detection sensor, and can detect 3-axis angular velocity and 3-axis acceleration. The microphone 141 accepts voice input.

The processing device 150 controls each element of the MR device 100. For example, the processing device 150 controls the display by the projection device 121 and the projection device 122. The processing device 150 detects the movement of the field of view based on the detection result by the sensor 140. The processing device 150 changes the display by the projection device 121 and the projection device 122 in response to the movement of the field of view. In addition, the processing device 150 can perform various processes using data obtained from the image camera 131 and the depth camera 132, the data of the storage device 170, etc.

The battery 160 supplies the power necessary for operation to each element of the MR device 100. The storage device 170 stores data necessary for the processing of the processing device 150, data obtained by the processing of the processing unit 150, etc. The storage device 170 may be provided outside the MR device 100 and communicate with the processing device 150.

Not limited to the illustrated example, the MR device according to the embodiment may be a monocular-type head mounted display. The MR device may be a glasses-type as illustrated, or may be a helmet type.

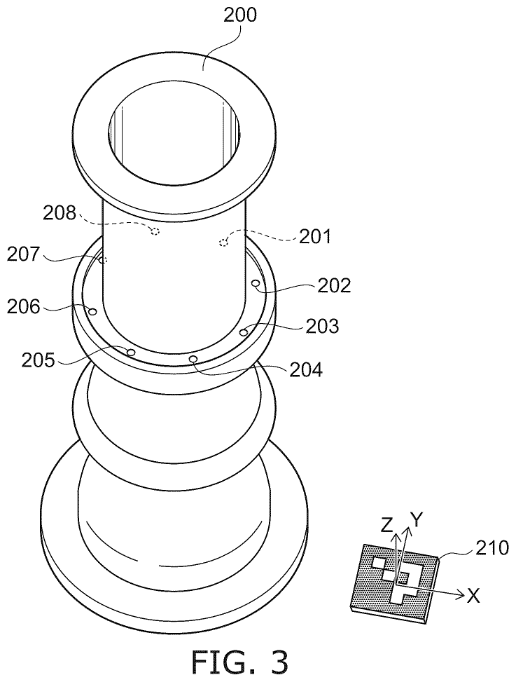

FIG. 3 is a schematic view illustrating an article to be worked.

For example, a fastening task is performed on the article 200 shown in FIG. 3. The article 200 is a cylindrical hollow member and has fastening locations 201 to 208. The worker uses a wrench to tighten a screw into each of the fastening locations 201 to 208.

A marker 210 is provided near the workpiece. In the illustrated example, the marker 210 is an AR marker. As will be described later, the marker 210 is provided for setting an origin of the three-dimensional coordinate system. Instead of the AR marker, a one-dimensional code (barcode), a two-dimensional code (QR code (registered trademark)), or etc. may be used as the marker 210. Alternatively, instead of a marker, the origin may be indicated by a hand gesture. The processing device 150 sets a three-dimensional coordinate system based on multiple points indicated by the hand gesture.

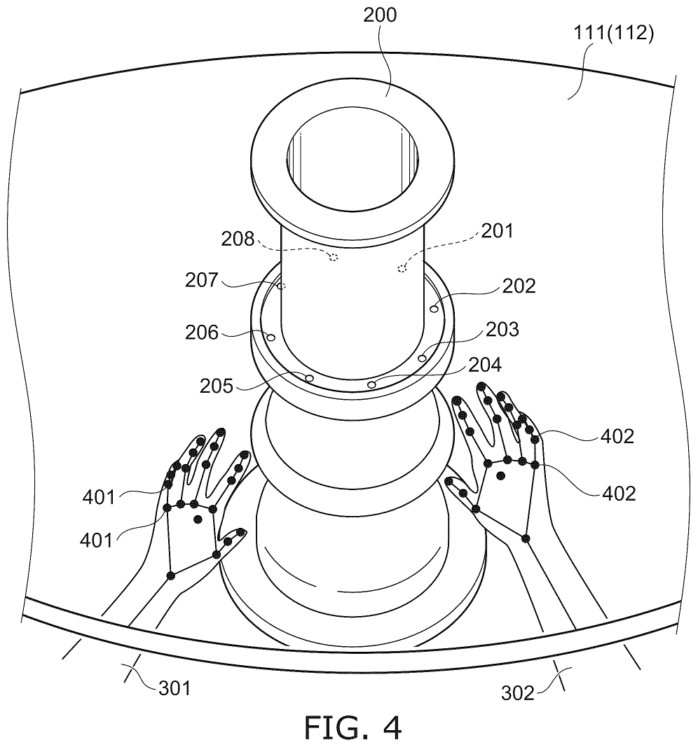

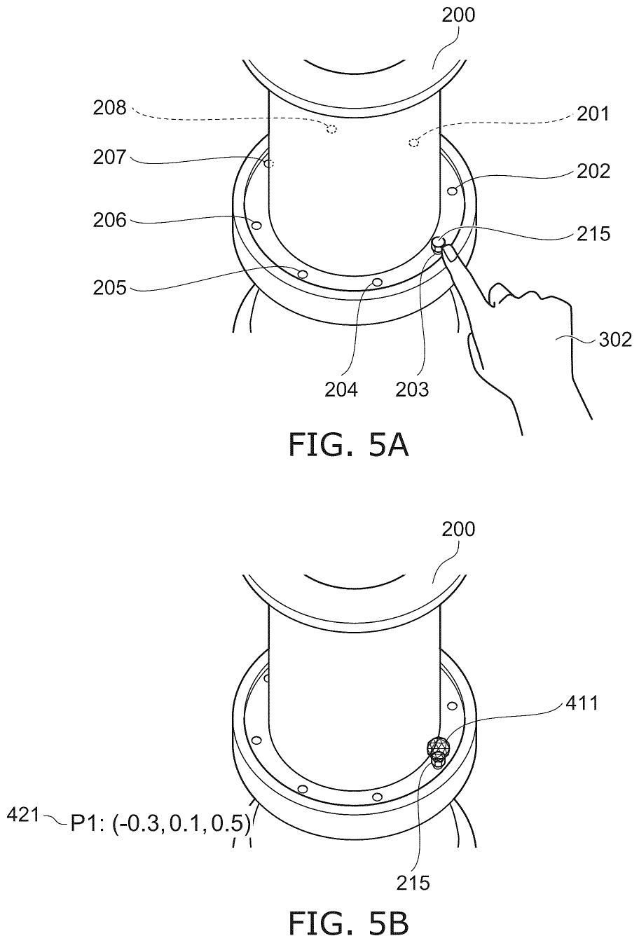

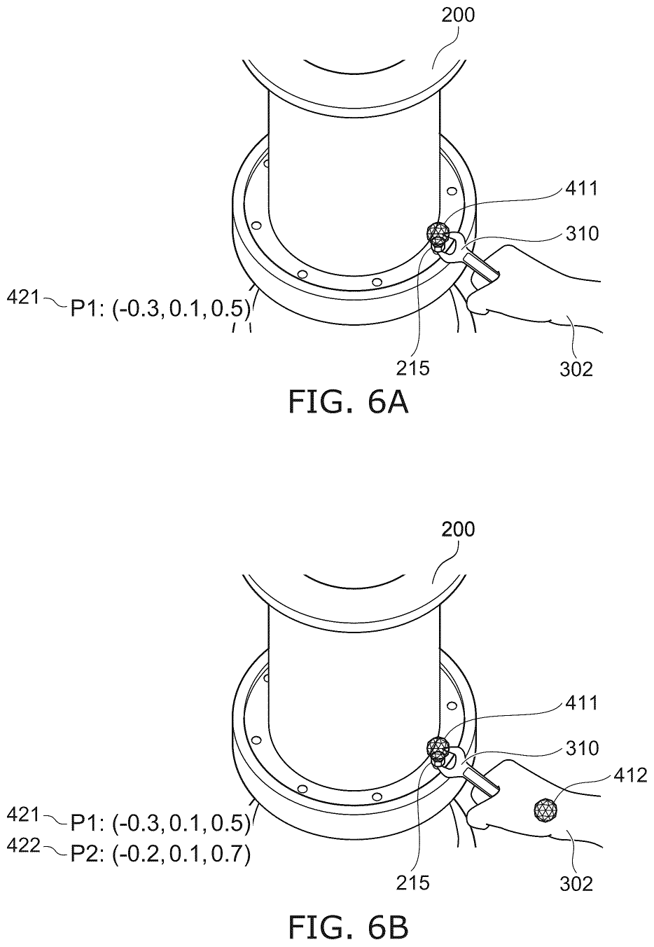

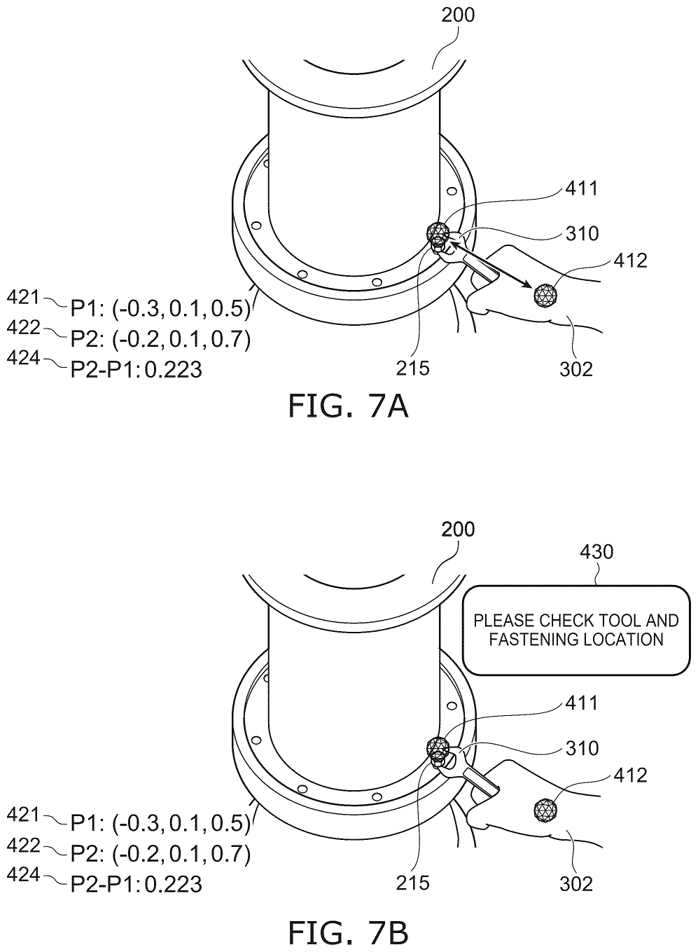

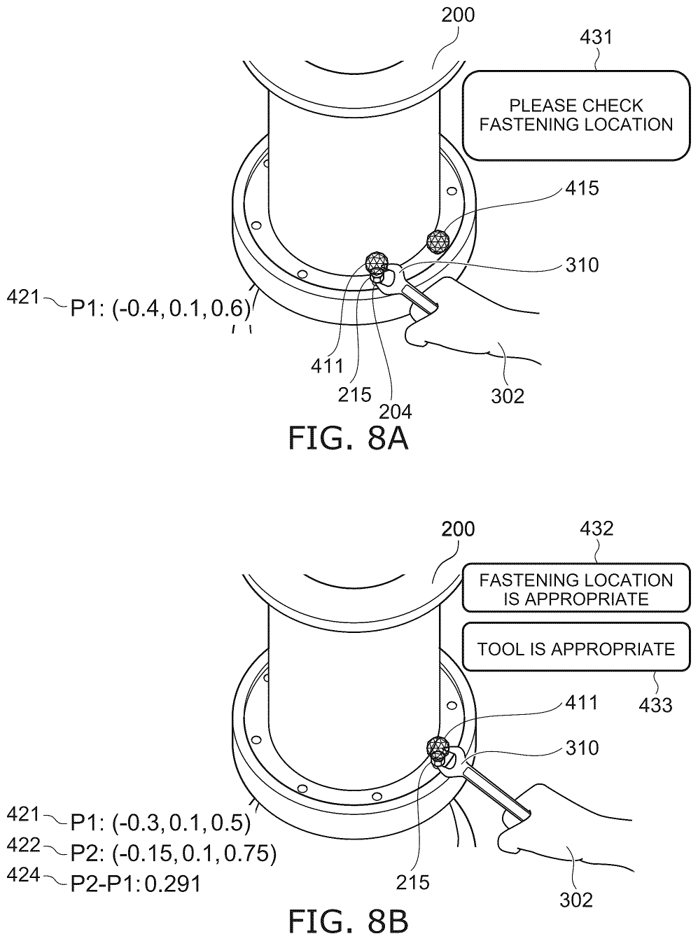

FIG. 4, FIG. 5A, FIG. 5B, FIG. 6A, FIG. 6B, FIG. 7A, FIG. 7B, FIG. 8A, and FIG. 8B are schematic views for explaining the first embodiment of the present invention.

For example, a worker wearing the MR device 100 performs fastening task on the article 200. The worker can see the article 200 and his or her hand through the lens 111 and the lens 112.

At the start of the fastening task, the image camera 131 and the depth camera 132 image the marker 210. The processing device 150 recognizes the marker 210 from the acquired image. The processing device 150 sets a three-dimensional coordinate system based on the position and orientation of the marker 210.

The image camera 131 and the depth camera 132 image the article 200, the left hand 301, and the right hand 302. The processing device 150 recognizes the left hand 301 and the right hand 302 from the acquired image. The processing device 150 causes the projection device 121 and the projection device 122 to display the recognition result on the lens 111 and the lens 112. Hereinafter, the processing device displays information on the lens using a projection device, which is also simply referred to as “the processing device displays information”.

For example, as shown in FIG. 4, the processing device 150 displays the recognition result of the left hand 301 and the recognition result of the right hand 302 overlaid on the hands in real space. In the illustrated example, multiple virtual objects 401 and multiple virtual objects 402 are displayed as results of the recognition of the left hand 301 and the right hand 302. The multiple virtual objects 401 represent multiple joints of the left hand 301, respectively. The multiple virtual objects 402 indicate multiple joints of the right hand 302, respectively. Instead of joints, virtual objects (meshes) respectively indicating the surface shape of the left hand 301 and the surface shape of the right hand 302 may be displayed.

FIG. 5A, FIG. 5B, FIG. 6A, FIG. 6B, FIG. 7A, FIG. 7B, FIG. 8A, and FIG. 8B are schematic views illustrating a part of the worker's field of view. The worker places the screw 215 at any of the fastening locations 201 to 208. As shown in FIG. 5A, the worker points with a finger to the head of the placed screw 215. When the screw 215 is short, the fastening location may be pointed before placing the screw 215. The processing device 150 recognizes the hand gesture of the pointing. The processing device 150 accepts the first position of the tip of the finger when pointed as a position indicating the fastening location, and measures the first position. The worker may specify the timing for measuring the first position by a voice command. When the processing device 150 receives the voice command, the processing device 150 measures the first position at that timing.

As shown in FIG. 5B, the processing device 150 displays a first virtual object 411 at the measured first position. In the illustrated example, the first virtual object 411 is a sphere. As long as the worker can visually recognize it separately from the real space, the shape, color, etc. of the first virtual object 411 are arbitrary. The processing device 150 may display the coordinates 421 of the first virtual object 411.

As shown in FIG. 6A, the worker moves the right hand 302 holding the wrench 310 to the working position when fastening the screw 215. The processing device 150 measures the second position of the right hand 302. The worker may specify the timing for measuring the second position by voice. When the processing device 150 receives the voice command, the processing device 150 measures the second position at that timing. Alternatively, the worker may indicate the measurement timing of the second position to the processing device 150 using a hand gesture. For example, when the worker grips the wrench 310 with the right hand 302, the worker spreads and holds the right hand 302 toward the image camera 131 and the depth camera 132. When the processing device 150 recognizes this hand gesture, the processing device 150 measures the second position at that timing.

As shown in FIG. 6B, the processing device 150 displays a second virtual object 412 at the measured second position. In the illustrated example, the second virtual object 412 is a sphere. As long as the worker can visually recognize it separately from the real space, the shape, color, etc. of the second virtual object 412 are arbitrary. The processing device 150 may display the coordinate 422 of the second virtual object 412.

The processing device 150 calculates the first distance between the first position and the second position. The first distance corresponds to the length of the wrench 322 held by the worker. As shown in FIG. 7A, the processing device 150 may display the first distance 424.

For example, the processing device 150 calculates a first error between a pre-registered first length and the first distance. When the first error is greater than a preset first threshold value, the processing device 150 determines that the fastening task by the worker is not appropriate. If the first error is less than or equal to the first threshold value, the processing device 150 determines that the fastening task is appropriate.

As examples of tasks that are not appropriate, there are cases where the tool held by the worker is not appropriate, and cases where the worker is trying to fasten a different fastening location from the one pointed by. When the first error is greater than the first threshold value, the processing device 150 may display a message indicating that the fastening task is not appropriate. For example, the processing device 150 displays a message 430 encouraging confirmation of the tool or the fastening location, as shown in FIG. 7B. Instead of a message, an error code or the like may be displayed.

The length of the tool compared to the first distance may be another value calculated using the length of the registered tool. For example, the position of the grip of the tool may be considered, and the length of the registered tool may be multiplied by a predetermined ratio. The processing device 150 compares the value obtained by multiplying with the first distance.

The first threshold value is set in advance by an administrator of the processing system 10 or the like. Alternatively, the first threshold value may be calculated by the processing device 150 based on the first length of the referenced tool. For example, a value obtained by multiplying the first length by a predetermined ratio may be used as the first threshold value.

When the fastening order of the screws for the fastening locations 201 to 208 is predetermined, the processing device 150 may determine whether the pointed fastening location is appropriate. For example, the storage device 170 stores task procedures. The task procedures include the fastening order of the screws for the fastening locations 201 to 208, the coordinates of each of the fastening locations 201 to 208, etc. The coordinates of the fastening locations 201 to 208 are represented by the three-dimensional coordinate system based on the marker 210. The three-dimensional coordinate system used for the coordinates of the fastening locations 201 to 208 and the three-dimensional coordinate system set in the task are common.

After measuring the first position, the processing device 150 refers to the coordinate of the fastening location to be fastened. The processing device 150 calculates the error between the first position and the referenced coordinates. If the error is less than or equal to a preset threshold value, the processing device 150 determines that the pointed fastening location is appropriate. If the error is greater than the threshold value, the processing device 150 determines that the pointed fastening location is not appropriate. The threshold value may be set in advance by a person, or may be calculated by the processing device 150 based on the mutual distances among the fastening locations 201 to 208.

For example, when the pointed fastening location is determined to be appropriate, the processing device 150 accepts the measured first position and displays the first virtual object at the first location. When the fastening location is not determined to be appropriate, the processing device 150 does not accept the measured first position and does not display the first virtual object.

If the pointed fastening location is not appropriate, the processing device 150 may display a message. FIG. 8A shows an example where the worker points to fastening location 204 when fastening location 203 should be pointed to. As shown in FIG. 8A, the processing device 150 may display a message 431 encouraging confirmation that the fastening location to be worked on is appropriate. The processing device 150 may display the virtual object 415 at the fastening location to be fastened. The color or shape of the virtual object 415 may be different from the color or shape of other virtual objects so that the virtual object 415 can be easily distinguished from the first virtual object 411 or the second virtual object 412.

When the pointed fastening location is appropriate, the processing device 150 may display a message 432 indicating that the fastening location is appropriate, as shown in FIG. 8B. When the fastening task is appropriate, the processing device 150 may display a message 433 indicating that the tool is appropriate.

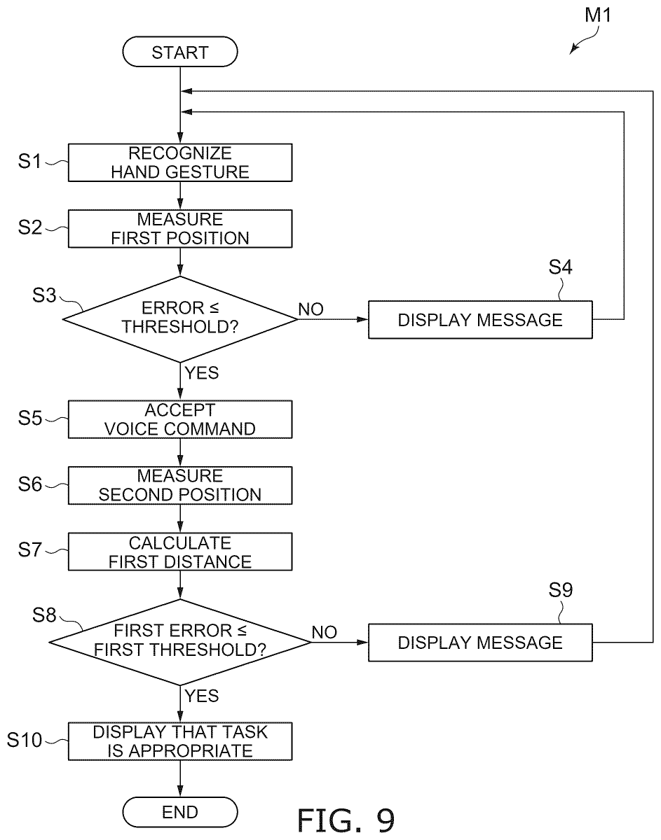

FIG. 9 is a flowchart illustrating a processing method according to the first embodiment.

In the processing method M1 shown in FIG. 9, when the fastening task is started, the worker indicates the fastening location by a hand gesture. The processing part 2 recognizes the hand gesture (step S1). The processing part 2 measures the first position indicated by the hand gesture (step S2).

The processing part 2 refers to the task procedures registered in advance and acquires the coordinate of the location to be fastened. The processing part 2 determines whether the error between the first position and the coordinate of the referenced fastening location is less than or equal to the threshold value (step S3). When the error is greater than the threshold value, the processing part 2 displays a message on the display part 4, encouraging confirmation of the fastening location (step S4).

If the error is less than or equal to the threshold value, the worker positions the hand holding the tool at the working position. The worker uses a voice command to indicate that the hand is at the working position. The processing part 2 receives the voice command (step S5) and measures the second position (step S6). The processing part 2 calculates the first distance between the first position and the second position (step S7). The processing part 2 determines whether the first error between the first distance and the first length of the pre-registered tool is less than or equal to the first threshold value (step S8). When the first error is greater than the first threshold value, the processing part 2 displays a message indicating that the task is not appropriate on the display part 4 (step S9). When the first error is less than or equal to the first threshold value, the processing part 2 displays on the display part 4 that the task is appropriate (step S10).

The advantages of the first embodiment will be described.

When manufacturing an article, screw fastening tasks may be performed. It is desirable that the screw is tightened into a fastening location using an appropriate tool. If the screw is tightened using an inappropriate tool, a failure may occur. For example, if a short tool is used when a long tool should be used, the torque applied to the screw will be small, which may result in an insufficient fastening force. The lack of fastening force reduces the reliability of the article. If a long tool is used when a short tool should be used, it can be difficult to tighten the screws. In addition, the tool will interfere with other objects, which will interrupt the task or damage other objects. There is also a possibility that task efficiency will decrease. Furthermore, the order of tightening the screws may be determined in advance depending on the article. In such a case, there is a possibility that the worker may inadvertently tighten the screw to a place different from the one intended. Conventionally, screw fastening tasks have been confirmed among multiple workers using a checklist, etc., but oversight may occur. In addition, since it takes time for the worker to confirm, the lead time for the manufacture of the article is long.

With respect to the problems, in the first embodiment, the processing part 2 measures the first position and the second position after the worker's hand is imaged. The first position corresponds to the fastening location of the screw. The second position corresponds to the position of the hand holding the tool. The processing part 2 determines whether the fastening task is appropriate based on the first distance between the first position and the second position. According to the processing part 2, it is possible to suppress that the screw is tightened using a tool different from the prescribed tool. Further, it is possible to suppress that a screw is mistakenly tightened into a fastening location different from the fastening location corresponding to the first position.

In addition, according to the processing, the processing part 2 can determine whether the task is appropriate before the worker tightens the screw. Therefore, it is possible to suppress the occurrence of redoing the screw-tightening. Further, the processing by the processing part 2 can be executed in real time according to the motion of the worker. For this reason, the effect on the lead time is also small. According to the first embodiment, it is possible to suppress inappropriate task while suppressing the extension of the lead time.

As a reference example, in order to determine whether the tool is appropriate, a method of recognizing the tool from an image and determining whether the recognized tool is appropriate may be adopted. However, in image recognition, it is difficult to calculate the length of the tool in three-dimensional space. In addition, since the tool is held by the worker during a task, part of the tool may be hidden by the hand and cannot be recognized. Therefore, it is difficult to calculate the length of the tool accurately. According to the embodiment, it is possible to more accurately determine whether the tool held by the worker is appropriate.

In addition, the image recognition requires a large amount of calculation. The load on the processing part 2 is large, and the processing part 2 and the MR device may become larger. Since the MR device is worn by a person, it is desirable that the MR device is small and lightweight. According to the first embodiment of the present invention, it is possible to determine whether the task is appropriate with a smaller amount of calculation, and it is possible to suppress the enlargement of the processing part 2. Therefore, the first embodiment of the present invention is particularly appropriate for MR devices that require miniaturization.

Preferably, the processing part 2 compares the first position with the position of the fastening location of the screw registered in advance. The processing part 2 determines whether the part where the worker intends to tighten the screw is appropriate. Thereby, it is possible to suppress the screw from being tightened into the wrong location. For example, screws may be respectively tightened into multiple fastening locations in a predetermined order. Even in such a case, the processing part 2 can suppress the screw from being tightened into the wrong location by determining whether the location to be tightened is appropriate.

The larger the article, the more screw fastening locations there are. In particular, for indented products (built-to-order products), the parts used for each article, the manufacturing procedure, etc. may differ. Therefore, exception tasks not listed in the checklist, oversights, etc. are more likely to occur. The first embodiment of the present invention is particularly appropriate for the manufacture of indented products.

When it is determined that the task is not appropriate, or that the fastening location is not appropriate, the processing part 2 outputs information (a message) indicating the contents. The worker can recognize from the message that the tool is not appropriate or that the fastening location is not appropriate.

The first position is indicated, for example, by a hand movement (a hand gesture). The processing part 2 measures the position indicated by the worker's hand gesture as the first position. By indicating the position to be measured, it is possible to suppress the measurement of a position that is not intended by the worker as the first position. It can improve the usability of MR devices.

Furthermore, the timing of measuring the first position may be indicated by a voice. The processing part 2 measures the first position at the indicated timing. By indicating the timing to be measured, it is possible to suppress the measurement of the first position at a timing that the worker does not intend. Thereby, the usability of the processing system 10 can be improved.

The timing for measuring the second position is also preferably indicated by a hand movement or a voice. The processing part 2 measures the second position at the indicated timing. By indicating the timing to be measured, it is possible to suppress the measurement of the second position at a timing that the worker does not intend. As a result, the usability of MR devices can be improved.

The tool may be a digital tool. The digital tool includes a sensor that detects the signal generated by the fastening task. The processing part 2 receives a detection value from the digital tool when the fastening task is performed. When the fastening task is appropriate, the processing part 2 associates the detection value with the pointed fastening location and stores it in the storage part 5. Thereby, a task record can be automatically generated for each fastening location. In a case where the worker records the detection value, the detection value may be incorrectly recorded for a fastening location different from the one where the task is actually performed. According to the first embodiment, it is possible to automatically generate a task record more accurately.

For example, a digital torque wrench or a digital torque screwdriver is used as the digital tool. When these digital tools are used, the detection value is torque. Alternatively, a threshold value may be set in advance for the torque. The digital torque wrench or digital torque screwdriver may determine whether or not a torque exceeding the threshold value has been detected, and may output the determination result as a detection value.

### Second Embodiment

A second embodiment of the present invention is applied to a fastening task in which multiple tools are used. For example, when screws are tightened, an extension bar and a wrench are used. The wrench tightens the screw via the extension bar.

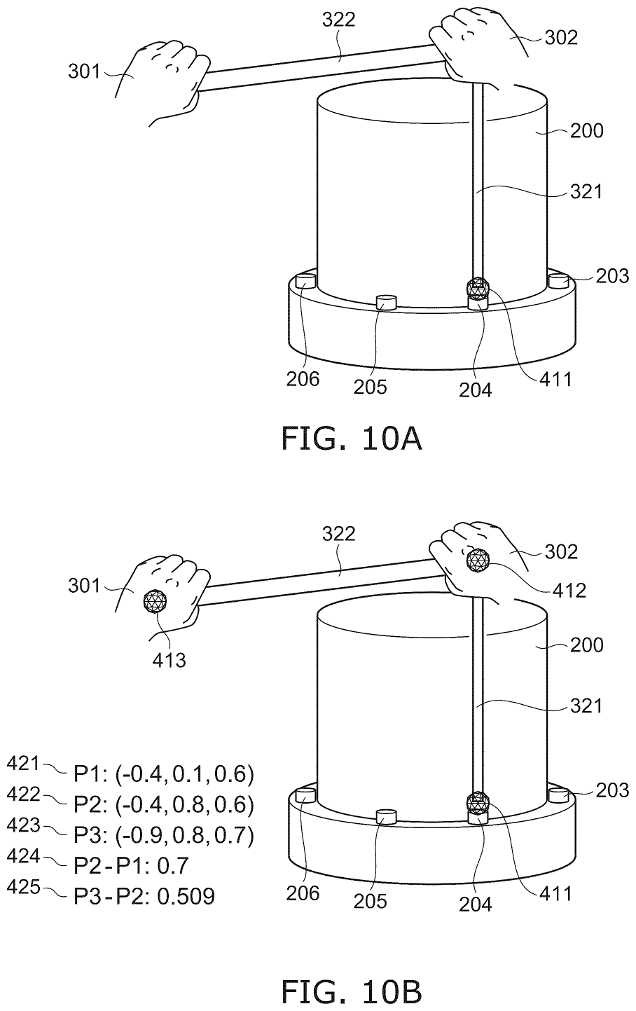

FIGS. 10A and 10B are schematic views for explaining the second embodiment of the present invention.

Here, an example in which a worker wearing the MR device 100 performs a fastening task on the article 200 using an extension bar and a wrench will be described.

First, as in the example shown in FIG. 4, the worker's hands are recognized. Similar to the examples shown in FIGS. 5A and 5B, the first position pointed by the worker is measured, and the first virtual object 411 indicating the first position is displayed.

Subsequently, as shown in FIG. 10A, the worker fits one end of the extension bar 321 to the pointed fastening location. The worker fits the wrench 322 to the other end of the extension bar 321. In the illustrated example, the first virtual object 411 is displayed at the fastening location 204. Further, one end of the wrench 322 in contact with the extension bar 321 is held by the right hand 302. The other end of the wrench 322 is held by the left hand 301.

The processing device 150 measures the second position of the right hand 302 and the third position of the left hand 301. For example, a voice command or a hand gesture indicates the timing of the measurements of the second and third positions. The voice command for causing the processing device 150 to measure the second position and the voice command for causing the processing device 150 to measure the third position may be prepared separately.

As shown in FIG. 10B, the processing part 2 displays the first to third virtual objects 411 to 413 at the first to third positions, respectively. The colors or shapes of the first to third virtual objects 411 to 413 are arbitrary and are not limited to the illustrated example. The processing device 150 may display the coordinates 421 to 423 of the first to third virtual objects 411 to 413.

It is specified in advance which of the left hand 301 and the right hand 302 corresponds to the second position or the third position. Alternatively, the processing device 150 may set the positions based on the handedness of the worker. For example, when a fastening task is performed, the processing device 150 refers to a database in which the worker's data is recorded. The processing device 150 acquires data of the worker performing the fastening task. The acquired data includes the handedness of the worker. The processing device 150 measures the position of the dominant hand as the third position, and measures the position of the non-dominant hand as the second position.

Alternatively, the processing device 150 may determine the second position and the third position based on the positional relationship between the first position, the position of the left hand 301, and the position of the right hand 302. As an example, the processing device 150 compares the distance between the first position and the left hand 301 with the distance between the first position and the right hand 302. The processing device 150 determines the position of the hand with the shorter distance as the second position, and the position of the hand with the longer distance as the third position. As another example, the extension bar 321 is often used in a vertical position. The processing device 150 compares the horizontal distance between the first position and the left hand 301 with the horizontal distance between the first position and the right hand 302. The processing device 150 determines the position of the hand with the shorter distance as the second position, and the position of the hand with the longer distance as the third position.

The processing device 150 calculates the first distance between the first and second positions. Further, the processing device 150 calculates the second distance between the second position and the third position. The first distance corresponds to the length of the extension bar 321. The second distance corresponds to the length of the wrench 322. As shown in FIG. 10B, the processing device 150 may display a first distance 424 and a second distance 425.

The processing device 150 calculates the first error between the first length registered in advance and the first distance. The first length is the length of the extension bar that is supposed to be used in the fastening task. Another value calculated using the length may be used as the first length.

Further, the processing device 150 calculates the second error between the second length registered in advance and the second distance. The second length is the length of the wrench that is supposed to be used in the fastening task. Another value calculated using the length may be used as the second length.

When the first error is greater than the first threshold value or the second error is greater than the second threshold value, the processing device 150 determines that the fastening task by the worker is not appropriate. When the first error is less than or equal to the first threshold value and the second error is less than or equal to the second threshold value, the processing device 150 determines that the fastening task is appropriate. The second threshold value may be the same as the first threshold value or may be different from the first threshold value.

When the first error is greater than the first threshold value, or when the second error is greater than the second threshold value, the processing device 150 may display a message. The message displayed when the first error is greater than the first threshold value may be different from the message displayed when the second error is greater than the second threshold value.

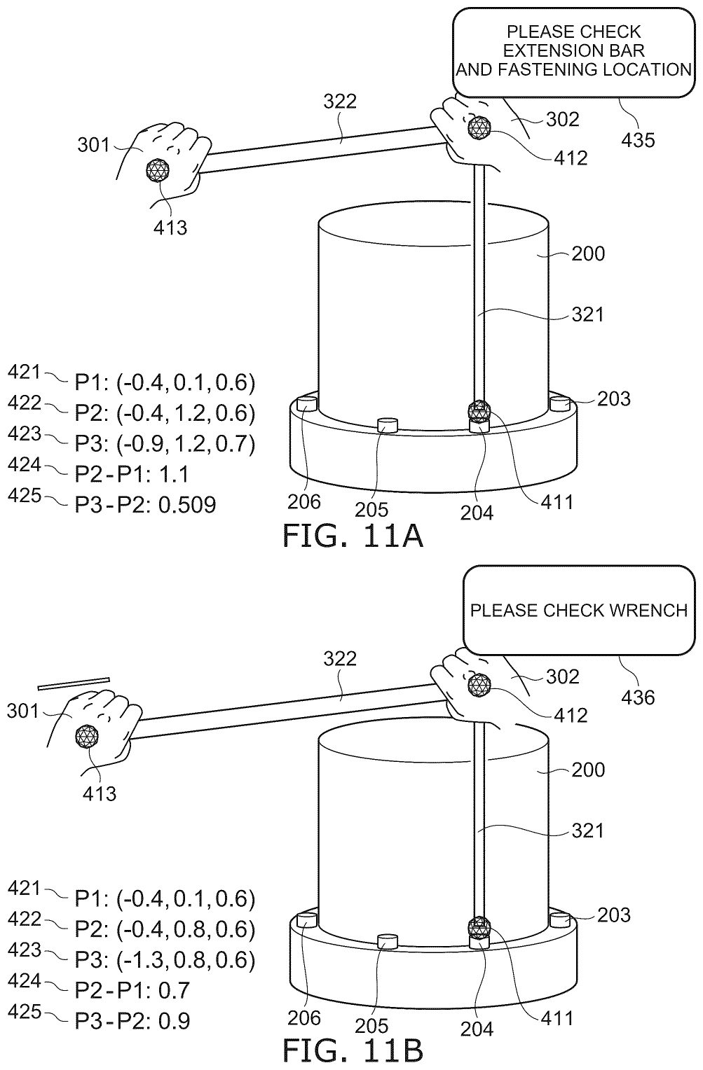

FIGS. 11A and 11B are schematic views illustrating output examples in the second embodiment of the present invention.

For example, when the first error is greater than the first threshold value, the processing device 150 displays a message 435 encouraging confirmation of the extension bar 321 or the fastening location, as shown in FIG. 11A. When the second error is greater than the second threshold value, the processing device 150 displays a message 436 encouraging confirmation of the wrench 322 as shown in FIG. 11B.

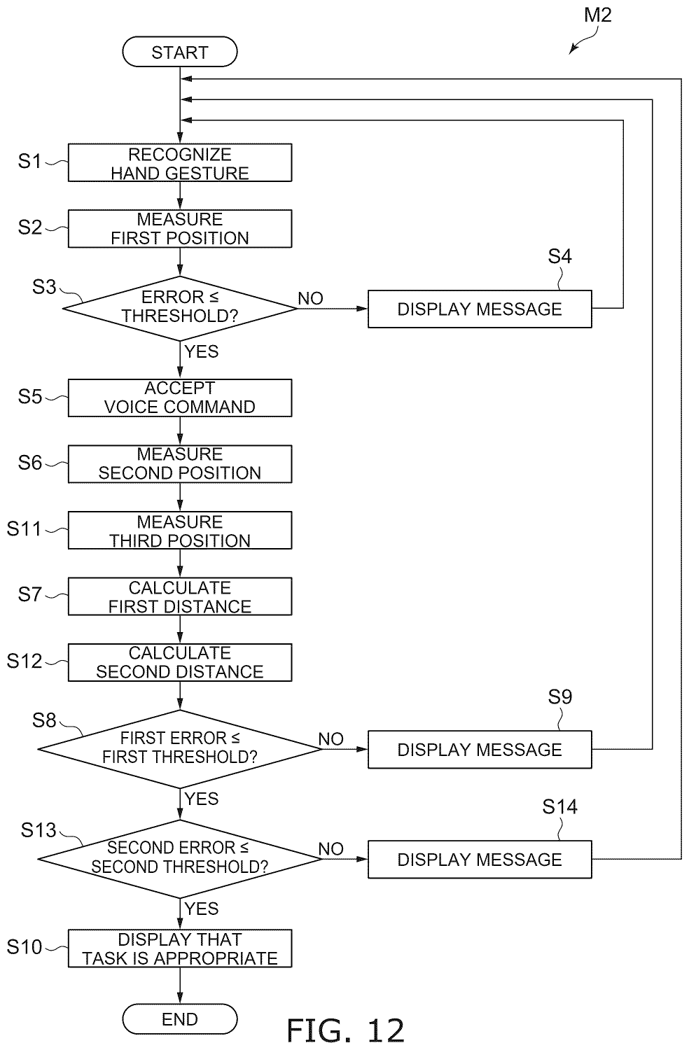

FIG. 12 is a flowchart illustrating an example of a processing method according to the second embodiment.

The processing method M2 shown in FIG. 12 further includes steps S11 to S14 compared to the processing method M1 shown in FIG. 9. First, steps S1 to S3 are executed in the same manner as the processing method M1. In the step S3, when the error is less than or equal to the threshold value, the worker moves the first tool and the second tool to the working position at which the screw is tightened. The worker indicates that both hands are at the working position by a voice command. The processing part 2 receives the voice command (step S5).

The processing part 2 recognizes the second position of one of the left hand 301 and the right hand 302 (step S6). The processing part 2 recognizes the third position of the other one of the left hand 301 and the right hand 302 (step S11). The processing part 2 calculates the first distance between the first position and the second position (step S7). The processing part 2 calculates the second distance between the second position and the third position (step S12).

The processing part 2 determines whether the first error between the first length of the first tool registered in advance and the first distance is less than or equal to the first threshold value (step S8). The processing part 2 determines whether the second error between the second length of the second tool registered in advance and the second distance is less than or equal to the second threshold value (step S13). When the first error is greater than the first threshold value, or when the second error is greater than the second threshold value, the processing part 2 displays a message on the display part 4 (step S9 or S14). When the first error is less than or equal to the first threshold value and the second error is less than or equal to the second threshold value, the processing part 2 displays on the display part 4 that the fastening task (the fastening location and the tool) is appropriate (step S10).

According to the second embodiment, even when multiple tools are used in the fastening task, it can be determined whether the fastening task is appropriate. According to the second embodiment, as in the first embodiment, it is also possible to suppress an inappropriate task while suppressing the extension of the lead time.

The timings of measuring the first to third positions are preferably indicated by a hand movement or a voice. The processing part 2 measures each position at the indicated timing. Thereby, it is possible to suppress the measurement of each position at a timing that the worker does not intend. The usability of the processing system 10 can be improved.

### First Modification

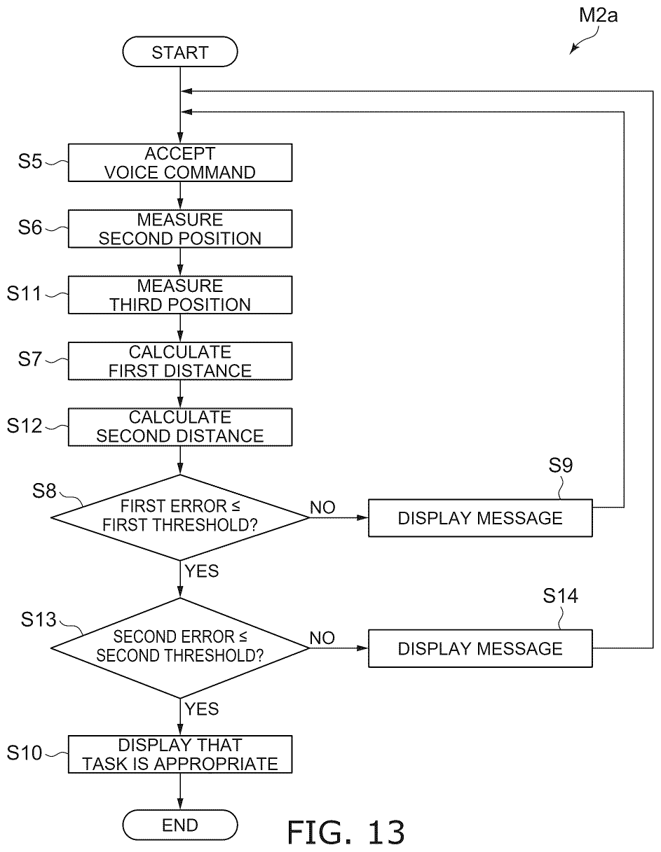

FIG. 13 is a flowchart illustrating a processing method according to the first modification of the second embodiment.

In the processing method M2 shown in FIG. 12, the determination of the fastening location may be omitted. For example, as in the processing method M2a shown in FIG. 13, the steps S1 to S4 may be omitted and processing may be started from the step S5. In such a case, it is determined whether each of the first tool and the second tool is appropriate.

### Second Modification

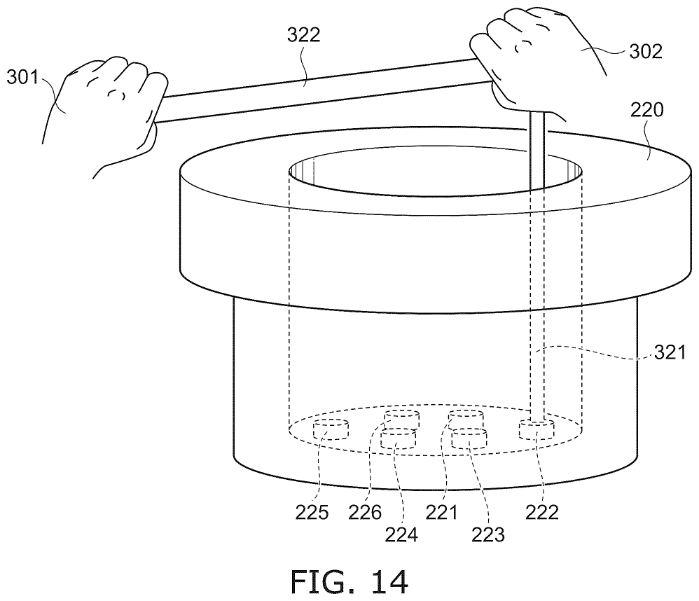

FIG. 14 is a schematic view for explaining a second modification of the second embodiment.

The fastening location of the screw may exist in a position that is difficult to see. In the example shown in FIG. 14, a screw is tightened to the tubular article 220. The inside of the article 220 is a cavity. At the bottom of the cavity, there are multiple fastening locations 221 to 226. The worker places a screw at one of the fastening locations and inserts the extension bar 321 into the cavity. The worker tightens the screw using the extension bar 321 and the wrench 322.

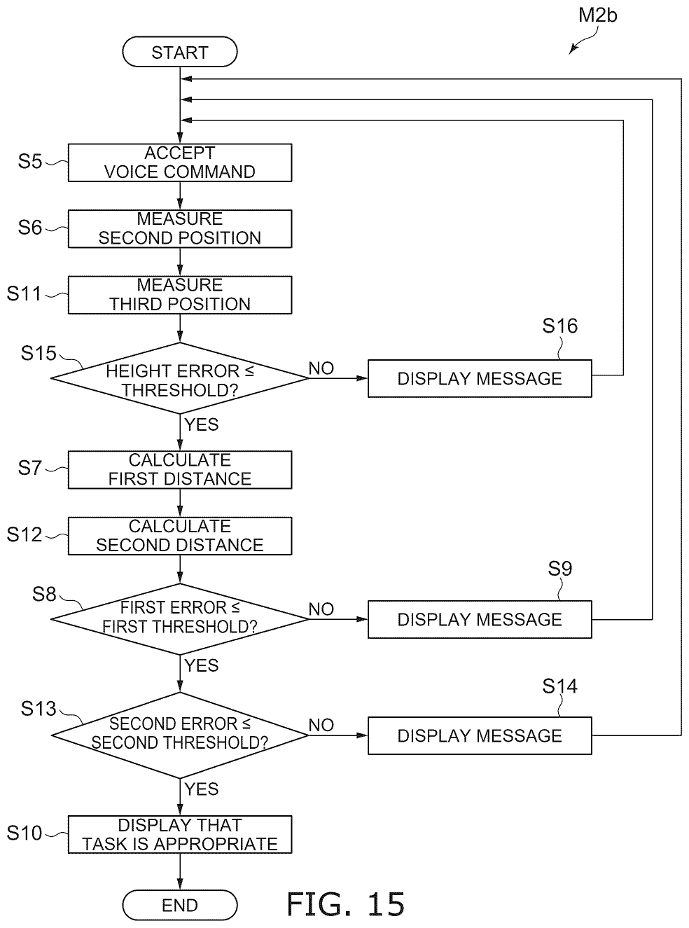

FIG. 15 is a flowchart illustrating a processing method according to the second modification of the second embodiment.

A part of the extension bar 321 and the fastening location to which the screw is tightened are not imaged by the imaging part 1. Therefore, as in the first modification, the steps S1 to S4 are omitted in the processing method M2b shown in FIG. 15. The processing method M2b further includes steps S15 and S16 compared to the processing method M2a shown in FIG. 13.

After the steps S6 and S11 are performed, the processing part 2 calculates the error between the height of the second position and the height of the third position. The processing part 2 determines whether the height error is less than or equal to a preset threshold value (step S15). As described above, the extension bar 321 is often used in a vertical position. The wrench 322 is fixed perpendicular to the extension bar 321. Therefore, when the orientation of each tool is appropriate, the height of the hand holding one end of the wrench 322 and the height of the other hand holding the other end of the wrench 322 are substantially the same.

When the height error is greater than the threshold value, the processing part 2 displays a message indicating that the task is not appropriate (step S16). The processing part 2 may indicate that the orientation of the tool is not appropriate by the message. When the height error is less than or equal to the threshold value, the steps S7 and later are performed in the same manner as in the processing method M2.

According to the second modification of the second embodiment, it can be determined whether the tool used by the worker is appropriate. In the processing method M2 shown in FIG. 12, the steps S15 and S16 may be further performed. Thereby, in addition to determining whether or not the fastening location is appropriate, it is also possible to determine whether or not the tool is used appropriately. It can encourage workers to perform fastening tasks more appropriately.

### Third Embodiment

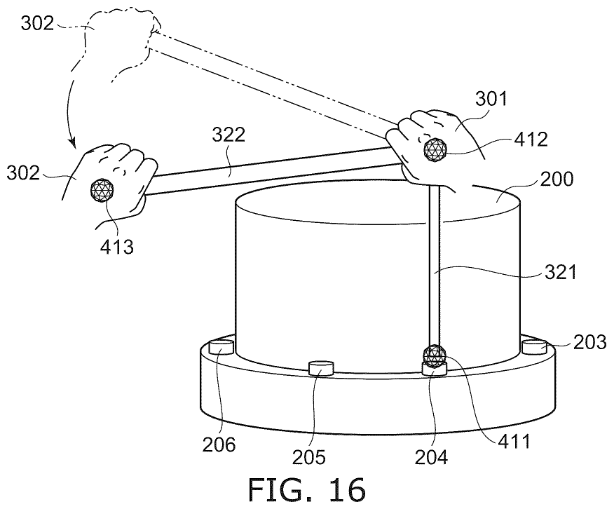

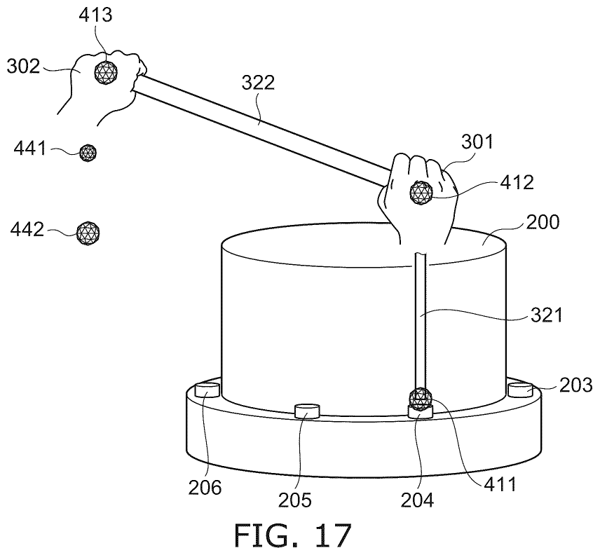

FIGS. 16 and 17 are schematic views for explaining a third embodiment of the present invention.

The third embodiment of the present invention is used after the start of fastening task. First, according to the second embodiment of the present invention, the first to third positions are measured. When the task is determined to be appropriate, the worker starts the screw-tightening. In the fastening task using the extension bar 321 and the wrench 322, as shown in FIG. 16, the wrench 322 rotates along a horizontal plane around the extension bar 321.

When the first to third positions are measured and the task is determined to be appropriate, the processing part 2 sets one or more passing points. The passing point is set to a position where the hand holding the wrench 322 passes when the fastening task is appropriately performed. The direction of rotation of the wrench 322 is determined based on the orientation of the screw thread at the fastening location.

In the illustrated example, the screw thread at the fastening location is in the opposite direction from the general screw thread. Therefore, the wrench 322 is rotated counterclockwise when the screw is tightened. For example, the processing part 2 sets two passing points. As shown in FIG. 17, the processing part 2 may display a virtual object 441 and a virtual object 442 at the positions of the set passing points.

When the fastening task starts, the processing part 2 determines whether the hand holding one end of the wrench 322 has passed through the passing point. When the hand passes through the passing point, the processing part 2 determines that the task is appropriately performed. The processing part 2 may indicate that the hand has passed through the passing point or that the task is appropriate.

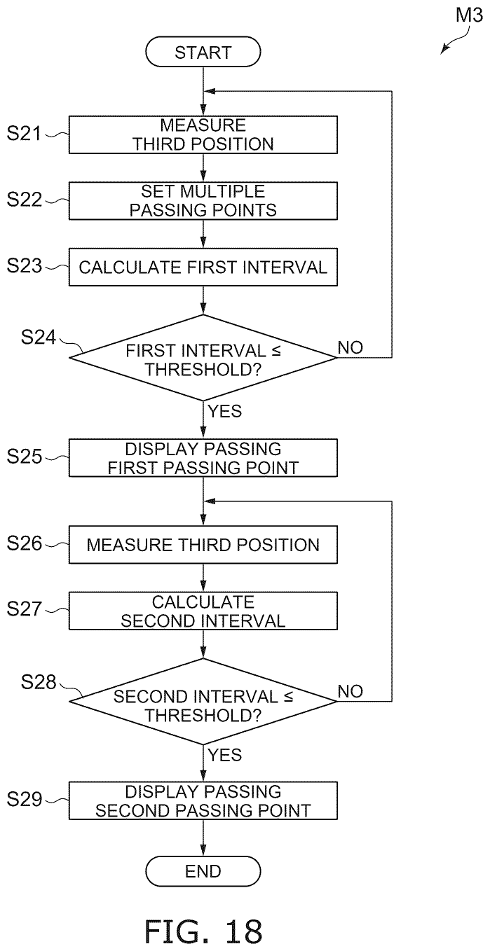

FIG. 18 is a flowchart illustrating a processing method according to the third embodiment.

In the processing method M3 shown in FIG. 18, first, the processing part 2 measures the third position (step S21). The processing part 2 sets multiple passing points (step S22). For example, the processing part 2 sets a first passing point and a second passing point. More passing points may be set.

The first passing point is located between the third position and the second passing point. The processing part 2 calculates the first interval between the first passing point and the third position (step S23). The processing part 2 determines whether the first interval is less than or equal to a preset threshold value (step S24). When the first interval is greater than the threshold value, the step S21 is performed again and the third position is measured again.

When the first interval is less than or equal to the threshold value, the processing part 2 displays that the wrench 322 has passed the first passing point (step S25). The processing part 2 measures the third position (step S26). The processing part 2 calculates the second interval between the second passing point and the third position (step S27). The processing part 2 determines whether the second interval is less than or equal to a preset threshold value (step S28). When the second interval is greater than the threshold value, the step S26 is performed again and the third position is measured again. When the second interval is less than or equal to the threshold value, the processing part 2 displays that the wrench 322 has passed through the second passing point (step S29).

When three or more passing points are set, the same process is performed after the step S29. According to the third embodiment, the worker can be encouraged to use the tool appropriately.

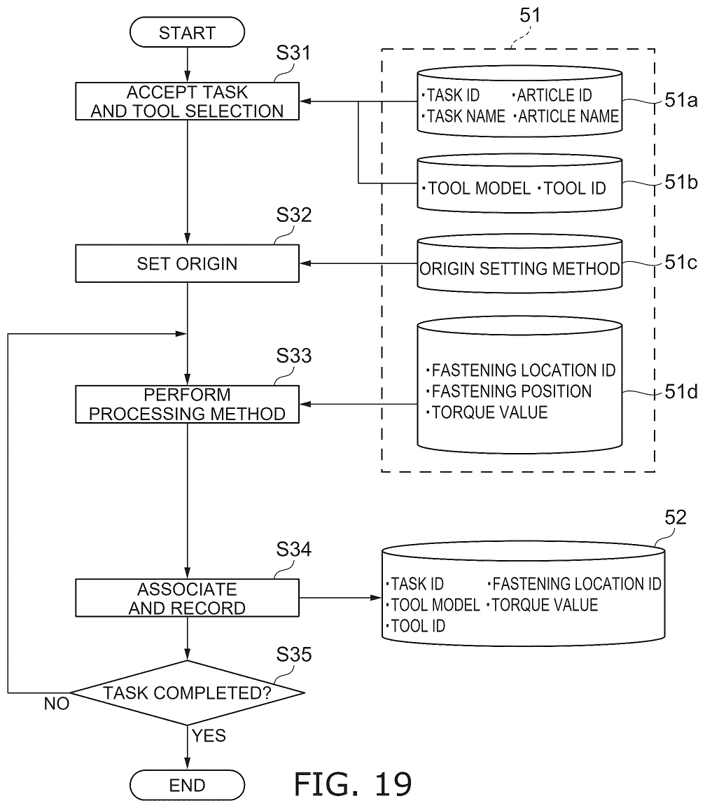

FIG. 19 is a flowchart illustrating an outline of data processing in the processing methods according to the embodiment.

The storage part 5 stores master data 51 and history data 52. The master data 51 includes task master data 51a, tool master data 51b, origin master data 51c, and fastening location master data 51d. The master data 51 is prepared in advance before a screw tightening.

The processing part 2 refers to the fastening task to be performed and the tool used (step S31). The fastening task and the tool may be selected by the worker or directed by a higher-level system. The task master data 51a stores a task ID, a task name, an article ID, and an article name related to the fastening task. The tool master data 51b stores the tool model and the tool ID. The tool model indicates the classification of the tool by structure, appearance, performance, etc. By specifying the tool model, the length of the tool is specified.

The processing part 2 refers to the origin master data 51c. The origin master data 51c stores a method for setting the origin for each task. The processing part 2 acquires the method for setting the origin in the task selected in step S31, and sets the origin according to the setting method (step S32). A marker or hand gesture is used to set the origin.

One of the above-described processing methods is performed (step S33). During performing the processing method, the processing part 2 refers to the fastening location master data 51d. In the fastening location master data 51d, fastening location IDs are stored, and a fastening position and a torque value are stored for each fastening location ID. The fastening position indicates the position of each fastening location. The torque value indicates the magnitude of the torque required when a screw is tightened into each fastening location. The length of the tool is specified by the model of the tool registered in the tool master data 51b. The length is compared with each distance. Thereby, the processing part 2 determines whether the task is appropriate.

When a digital tool is used, the processing part 2 receives data from the digital tool. The processing part 2 associates the received data with the task ID, data related to the fastening location, data related to the tool, etc., and records the data in the history data 52 (step S34). For example, from a digital tool, a torque value is transmitted. The processing part 2 records the torque value in association with the task ID, the fastening location ID, the model of the tool used, and the tool ID.

The processing part 2 determines whether the task selected in step S31 has been completed. When the task is not completed, the steps S33 and S34 are performed again.

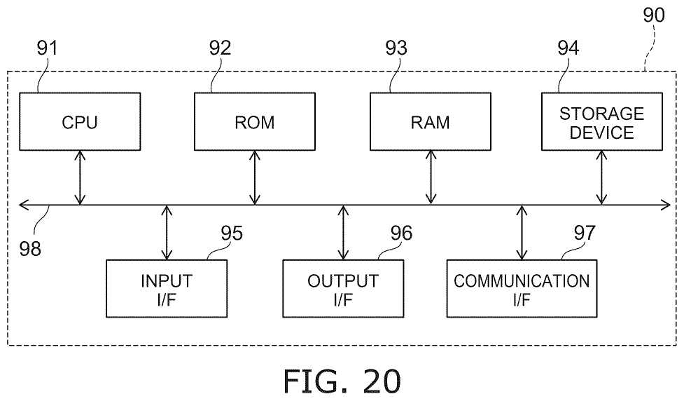

FIG. 20 is a schematic view illustrating a hardware configuration.

For example, a computer 90 shown in FIG. 20 is used as the processing part 2. The computer 90 includes a CPU 91, ROM 92, RAM 93, a storage device 94, an input interface 95, an output interface 96, and a communication interface 97.

The ROM 92 stores programs that control the operations of the computer 90. Programs that are necessary for causing the computer 90 to realize the processing described above are stored in the ROM 92. The RAM 93 functions as a memory region into which the programs stored in the ROM 92 are loaded.

The CPU 91 includes a processing circuit. The CPU 91 uses the RAM 93 as task memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes a solid state drive (SSD), etc. The storage device 94 may be used as the storage part 5 or the storage device 170.

The input interface (I/F) 95 can connect the computer 90 to the input part 3. The CPU 91 can read various data from the input part 3 via the input I/F 95.

The output interface (I/F) 96 can connect the computer 90 and an output device. The CPU 91 can transmit data to the display part 4 via the output I/F 96 and can cause the display part 4 to display information.

The communication interface (I/F) 97 can connect the computer 90 and a device outside the computer 90. For example, the communication I/F 97 connects the digital tool and the computer 90 by Bluetooth (registered trademark) communication.

The data processing of the processing part 2 or the processing device 150 may be performed by only one computer 90. A portion of the data processing may be performed by a server or the like via the communication I/F 97. The processing of the various data described above may be recorded, as a program that can be executed by a computer, in a magnetic disk (a flexible disk, a hard disk, etc.), an optical disk (CD-ROM, CD-R, CD-RW, DVD-ROM, DVD-R, DVD-RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

In the above description of the embodiment, primarily, an example in which the processing system 10 is realized as an MR device is explained. Embodiments of the present invention are not limited to this example. The processing system 10 may be realized using a general-purpose personal computer. In such a case, a keyboard, a microphone, a touch pad, or the like are used as the input part 3. A monitor is used as the display part 4. A general-purpose camera is used as the imaging part 1. The camera is taken from the side or above the worker so that the worker's hand can be photographed. The processing part 2 executes each of the above-described processes using the moving image acquired by the camera.

Embodiments of the present invention include the following features.

### Feature 1

A mixed reality device, comprising:
an imaging part configured to acquire an image; and
a processing part configured to recognize, from the image, a hand of a worker performing a fastening task and to determine whether the fastening task is appropriate based on a first distance between a first position corresponding to a fastening location of a screw and a second position of the hand holding a first tool.

### Feature 2

The mixed reality device according to claim 1, wherein
the processing part is configured to calculate a first error between a first length of the first tool registered in advance and the first distance, and determine that the fastening task is not appropriate in a case where the first error is greater than a first threshold value.

### Feature 3

The mixed reality device according to claim 1, wherein
the processing part is configured to determine whether the first position is appropriate by comparing the first position with a position of the fastening location registered in advance.

### Feature 4

The mixed reality device according to any one of features 1 to 3, wherein
in a case where the screw is tightened by a second tool via the first tool, the processing part recognizes two hands of the worker and determines whether the second tool is appropriate based on a second distance between the second position of one of the two hands and a third position of the other hand of the two hands.

### Feature 5

The mixed reality device according to claim 4, wherein
the processing part determines that the fastening task is not appropriate in a case where a difference between a height of the second position and a height of the third position exceeds a threshold value.

### Feature 6

The mixed reality device according to any one of features 1 to 5, wherein
the processing part is configured to measure the first position at a timing indicated by a hand gesture or a voice command.

### Feature 7

The mixed reality device according to any one of features 1 to 6, further comprising a display part,
the processing part is configured to cause the display part to display a first object indicating the first position and a second object indicating the second position.

### Feature 8

The mixed reality device according to any one of features 1 to 7, wherein in a case where a marker is imaged by the imaging part,
the processing part sets a three-dimensional coordinate system based on the marker and measures the first position and the second position in the coordinate system.

### Feature 9

The mixed reality device according to any one of features 1 to 8, wherein
in a case where the processing part receives a detection value when the screw is tightened, the processing part stores the detection value in association with data related to the fastening location.

### Feature 10

A mixed reality device, configured to:
cause a display part to display, overlaid on the real space, a recognition result of a left hand of a worker, a recognition result of a right hand of the worker, a first object indicating a first position corresponding to a fastening location of a screw, and a second object indicating a second position of one of the left hand and the right hand; and
cause the display part to display a message in a case where a tool held by either the left hand or the right hand is not appropriate.

### Feature 11

A processing method executed by a processing device, comprising:
measuring a first position corresponding to a fastening location of a screw;
recognizing a left hand and a right hand of a worker from an image of the worker holding a first tool;
determining whether a fastening task performed by the worker is appropriate based on a first distance between the first position and a second position of one of the left hand and the right hand.

### Feature 12

A processing device executing the processing method according to claim 11.

### Feature 13

A non-transitory computer-readable storage medium storing a program, the program causes a processing device to execute the processing method according to claim 11.

According to the embodiment described above, a mixed reality device, processing method, processing device, program, and storage medium capable of suppressing the execution of inappropriate task is provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A mixed reality device, comprising:
an imaging part configured to acquire an image; and
a processing part configured to recognize, from the image, a hand of a worker performing a fastening task and to determine whether the fastening task is appropriate based on a first distance between a first position corresponding to a fastening location of a screw and a second position of the hand holding a first tool.

2. The mixed reality device according to claim 1, wherein
the processing part is configured to calculate a first error between a first length of the first tool registered in advance and the first distance, and determine that the fastening task is not appropriate in a case where the first error is greater than a first threshold value.

3. The mixed reality device according to claim 1, wherein
the processing part is configured to determine whether the first position is appropriate by comparing the first position with a position of the fastening location registered in advance.

4. The mixed reality device according to claim 1, wherein
in a case where the screw is tightened by a second tool via the first tool, the processing part recognizes two hands of the worker and determines whether the second tool is appropriate based on a second distance between the second position of one of the two hands and a third position of the other hand of the two hands.

5. The mixed reality device according to claim 4, wherein
the processing part determines that the fastening task is not appropriate in a case where a difference between a height of the second position and a height of the third position exceeds a threshold value.

6. The mixed reality device according to claim 1, wherein
the processing part is configured to measure the first position at a timing indicated by a hand gesture or a voice command.

7. The mixed reality device according to claim 1, further comprising a display part,
the processing part is configured to cause the display part to display a first object indicating the first position and a second object indicating the second position.

8. The mixed reality device according to claim 1, wherein
in a case where a marker is imaged by the imaging part, the processing part sets a three-dimensional coordinate system based on the marker and measures the first position and the second position in the coordinate system.

9. The mixed reality device according to claim 1, wherein
in a case where the processing part receives a detection value when the screw is tightened, the processing part stores the detection value in association with data related to the fastening location.

10. A mixed reality device, configured to:
cause a display part to display, overlaid on a real space, a recognition result of a left hand of a worker, a recognition result of a right hand of the worker, a first object indicating a first position corresponding to a fastening location of a screw, and a second object indicating a second position of one of the left hand and the right hand; and
cause the display part to display a message in a case where a tool held by either the left hand or the right hand is not appropriate.

11. A processing method executed by a processing device, comprising:
measuring a first position corresponding to a fastening location of a screw;
recognizing a left hand and a right hand of a worker from an image of the worker holding a first tool;
determining whether a fastening task performed by the worker is appropriate based on a first distance between the first position and a second position of one of the left hand and the right hand.

12. A processing device executing the processing method according to claim 11.

13. A non-transitory computer-readable storage medium storing a program, the program causes a processing device to execute the processing method according to claim 11.
